(19) United States
(12) Patent Application Publication
(10) Pub. No.: US 2023/0229518 A1
(43) Pub. Date: Jul. 20, 2023

(54) CITY MANAGEMENT SUPPORT APPARATUS, CITY MANAGEMENT SUPPORT METHOD, AND NON-TRANSITORY COMPUTER-READABLE STORAGE MEDIUM

(71) Applicant: TOYOTA JIDOSHA KABUSHIKI KAISHA, Toyota-shi (JP)

(72) Inventor: Hideo HASEGAWA, Tokyo-to (JP)

(73) Assignee: TOYOTA JIDOSHA KABUSHIKI KAISHA, Toyota-shi (JP)

(21) Appl. No.: 17/990,060

(22) Filed: Nov. 18, 2022

(30) Foreign Application Priority Data
Jan. 18, 2022 (JP) 2022-005876

(51) Int. Cl. G06F 9/50; G06F 9/38

(52) U.S. Cl. CPC G06F 9/5061; G06F 9/505; G06F 9/3838

(57) ABSTRACT

The city management support apparatus is an apparatus supporting management of a city in which a plurality of services sharing a physical resource are provided. The city management support apparatus receives an input of information on a provision status of the resource, and receives an input of a service definition for each of the plurality of services. The city management support apparatus calculates a time transition of dependency of the plurality of services on the resource based on the service definition for each of the plurality of services, and detects a competition for acquisition of the resource among the plurality of services based on the time transition of the dependency. The city management support apparatus generates a proposed amendment to the service definition for at least one of the plurality of services so as to optimize the competition for the acquisition of the resource among the plurality of services.

### CROSS-REFERENCE TO RELATED APPLICATION

The present application claims priority under 35 U.S.C. § 119 to Japanese Patent Application No. 2022-005876, filed Jan. 18, 2022, the contents of which application are incorporated herein by reference in their entirety.

### BACKGROUND

### Field

The present disclosure relates to a city management support apparatus, a city management support method, and a non-transitory computer-readable storage medium storing a city management support program suitable for use in management of a city in which a plurality of services sharing a physical resource are provided.

### Background Art

Today, “cities” where services are centrally managed through smart technology are being studied and planned in many locations. The term “city” as used herein means a physical space where people live by being provided with various services, and includes not only a large-scale space such as a so-called smart city but also a medium-scale space such as an underground mall and a small-scale space such as a large-scale building. In many cases, physical resources provided in such cities are shared by a plurality of services. In order to maintain the service level in an entire city, city management capable of optimizing the relationship between resources and services is required.

However, it is difficult to say that research has been sufficiently advanced so far on the management of a city where a plurality of services sharing physical resources are provided. For example, JP2005-045887A discloses a prior art in which supply and demand plans created by a plurality of business operators are collected in a predetermined format, a business operator causing supply and demand shortage and his/her shortage amount are searched from the supply and demand plans, a business operator capable of accommodation, his/her accommodation possible amount, and his/her accommodation unit price are searched from the supply and demand plans, and a supply and demand accommodation plan is calculated based on the search results. However, in the prior art, optimization of the relationship between resources and services among a plurality of services sharing physical resources is not considered.

In addition to JP2005-045887A, WO2013/084268 can be exemplified as a document indicating the technical level of the technical field related to the present disclosure.

### SUMMARY

The present disclosure has been made in view of the above-described problem, and an object thereof is to provide a technique that, in a city in which a plurality of services sharing a physical resource are provided, contributes to optimization of a relationship between the resource and the plurality of services.

### Means for Solving the Problems

In order to achieve the above object, the present disclosure provides a city management support apparatus. The city management support apparatus of the present disclosure is an apparatus that supports management of a city in which a plurality of services sharing a physical resource are provided. The city management support apparatus according to the present disclosure includes at least one memory storing at least one program and at least one processor executing the at least one program. The at least one program is configured to cause the at least one processor to execute receiving an input of information on a provision status of the resource, and receiving an input of a service definition for each of the plurality of services. Further, the at least one program is configured to cause the at least one processor to execute calculating a time transition of dependency of the plurality of services on the resource based on the service definition for each of the plurality of services, and detecting a competition for acquisition of the resource among the plurality of services based on the time transition of the dependency. Further, the at least one program is configured to cause the at least one processor to execute generating a proposed amendment to the service definition for at least one of the plurality of services so as to optimize the competition for the acquisition of the resource among the plurality of services.

In addition, in order to achieve the above object, the present disclosure provides a city management support method. The city management support method according to the present disclosure is a method for supporting, using a computer, management of a city in which a plurality of services sharing a physical resource are provided. The city management support method according to the present disclosure comprises inputting information on a provision status of the resource into the computer, and inputting a service definition for each of the plurality of services into the computer. Furthermore, the city management support method according to the present disclosure comprises calculating, by the computer, a time transition of dependency of the plurality of services on the resource based on the service definition for each of the plurality of services, and detecting, by the computer, a competition for acquisition of the resource among the plurality of services based on the time transition of the dependency. Furthermore, the city management support method according to the present disclosure comprises generating, by the computer, a proposed amendment to the service definition for at least one of the plurality of services so as to optimize the competition for the acquisition of the resource among the plurality of services.

Further, in order to achieve the above object, the present disclosure provides a city management support program. The city management support program according to the present disclosure is a program for supporting, using a computer, management of a city in which a plurality of services sharing a physical resource are provided. The city management support program according to the present disclosure is configured to cause the computer to execute receiving an input of information on a provision status of the resource, and receiving an input of a service definition for each of the plurality of services. Further, the city management support program according to the present disclosure is configured to cause the computer to execute calculating a time transition of dependency of the plurality of services on the resource based on the service definition for each of the plurality of services, and detecting a competition for acquisition of the resource among the plurality of services based on the time transition of the dependency. Further, the city management support program according to the present disclosure is configured to cause the computer to execute generating a proposed amendment to the service definition for at least one of the plurality of services so as to optimize the competition for the acquisition of the resource among the plurality of services.

According to the above-described technique of the present disclosure, when there is a competition for acquisition of the resource among the plurality of services, a proposed amendment to the service definition is generated for at least one service so as to optimize the competition. When the city manager recommends the proposed amendment to the service definition to the service provider, and the service provider amends the service definition in accordance with the proposed amendment, the relationship between resources and services can be optimized.

In the above-described technique of the present disclosure, a proposed change to provision of the resource may be generated so as to optimize the competition for the acquisition of the resource among the plurality of services. When the provision status of the resource is changed in accordance with the proposed change, the relationship between the resource and the plurality of services can be further optimized.

As described above, the technique of the present disclosure contributes to optimization of a relationship between a resource and services, and is useful in management of a city in which a plurality of services sharing a physical resource are provided.

### BRIEF DESCRIPTION OF THE DRAWINGS

FIG. 1 is a diagram showing an overview of a city according to an embodiment of the present disclosure.

FIG. 2 is a block diagram illustrating a configuration of a city management support apparatus according to the embodiment of the present disclosure.

FIG. 3 is a diagram illustrating an example of a usage relationship between services provided in the city and resources.

FIG. 4 is a diagram illustrating an example of dependency graph illustrating a time transition of dependency of the services illustrated in FIG. 3 on the resource.

FIG. 5 is a diagram illustrating an example of a service definition of an EV public bus service.

FIG. 6 is a diagram illustrating an example of a service definition of a micro-mobility logistics service.

FIG. 7 is a diagram illustrating an example of a display of a resource monitor.

FIG. 8 is a diagram illustrating an example of a display of the service monitor.

FIG. 9 is a diagram illustrating an example of a proposed amendment to the service definition of the micro-mobility logistics service.

### DETAILED DESCRIPTION

Hereinafter, an embodiment of a city management support apparatus, a city management support method, and a city management support program according to the present disclosure will be described with reference to the drawings. However, in the embodiment described below, when a numerical value such as the number, quantity, amount, or range of each element is mentioned, the present invention is not limited to the mentioned numerical value unless otherwise specified or unless it is clearly specified to the numerical value in principle. In addition, structures and the like described in the following embodiment are not necessarily essential to the present invention except for a case where the structures and the like are clearly specified in particular or a case where the structures and the like are obviously specified in principle.
1. City Overview

In the present disclosure, a city refers to a physical space in which people live by receiving the provision of various services. There is no limitation on the size of a city in the present disclosure. A smart city is an example of a large city, an underground mall is an example of a medium-sized city, and a large building is an example of a small city. A virtual space of the Internet that is not a physical space is not included in a city in the present disclosure.

In a city, various services are provided to users. Services are provided using resources of the city. Resources are those used to provide services in a city and include, for example, roads, charging stations, networks, electricity, water, and the like. If the logistics service uses elevators in the building, the elevators are also included in the resources. However, the resources in the present disclosure are finite physical resources, and those that are infinite or finite but non-physical are not included in the resources in the present disclosure. In a city in this disclosure, physical resources are shared by a plurality of services.

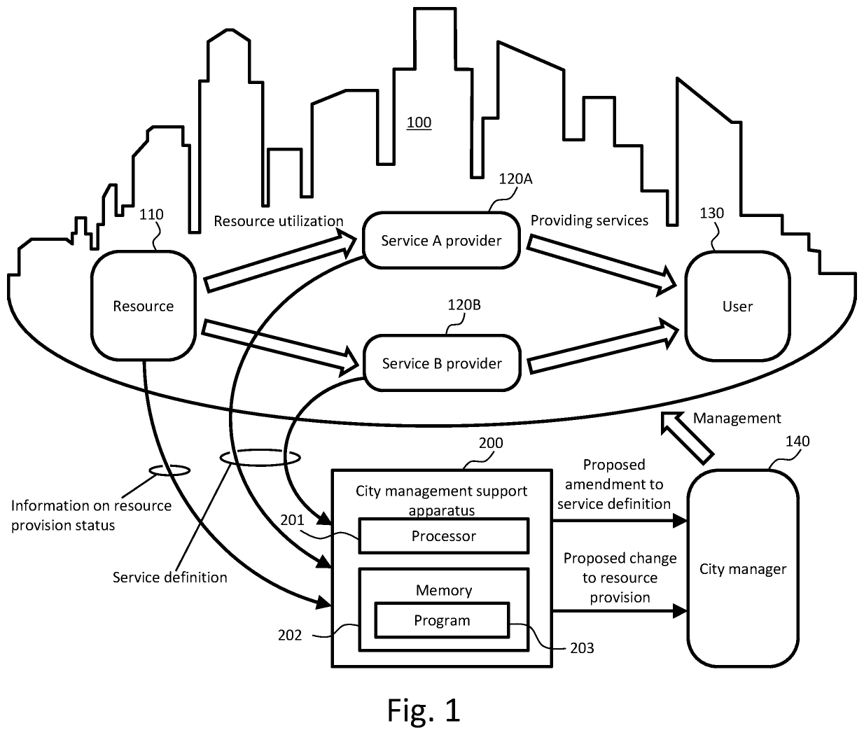

FIG. 1 shows an overview of a city 100 according to an embodiment of the present disclosure. In the city 100 according to this embodiment, services A and B sharing a physical resource 110 are provided to a user 130 from providers 120A and 120B of the services A and B. Although two services A and B are illustrated here, the number of services provided in the city 100 is more than one and is not limited to two.

The resource 110 includes a first type resource that can be used by both the services A and B at the same time and a second type resource that can be used by only one of the services A and B. When the resource 110 is used by three or more services, the first type resource is defined as a resource that can be simultaneously used by all of the plurality of services, and the second type resource is defined as a resource that can be simultaneously used by only a part of the plurality of services.

The provision status of each of the services A and B to the user 130 depends on the provision status of the resource 110 in the city 100. The dependency of each of the services A and B on the resource 110 changes from moment to moment, and a competition may occur between the services A and B particularly in the second type resource. When a competition occurs between the services A and B in acquiring the resource 110, the provision levels of the services A and B are lowered. Therefore, in order to maintain the service level of the entire city 100, city management capable of optimizing the relationship between the resource 110 and the services A and B is required.

In the city 100 according to the present embodiment, the provision statuses of the services A and B are collectively managed by the city manager 140 together with the provision status of the resource 110. The city manager 140 monitors the provision status of the resource 110, and has the authority and responsibility to quickly recover if an abnormality occurs in the provision status of the resource 110. However, depending on the type of the resource 110, the city manager 140 may entrust regular maintenance or restoration from an abnormality to another company, or the provision itself of the resource 110 may be performed by another company. The city manager 140 is basically a business operator different from the service providers 120A and 120B. Except for the case where the city manager 140 provides the service by itself, the city manager 140 basically cannot change the method of providing the service.

In the city 100 according to the present embodiment, the city manager 140 is required to efficiently and appropriately manage both the resource 110 and the services A and B due to the continuous development of the city 100. A city management support apparatus 200 according to the embodiment of the present disclosure is an apparatus for supporting efficient and appropriate management of the city 100 by the city manager 140. The city management support apparatus 200 is a computer comprising at least one memory 202 storing at least one program 203 and at least one processor 201 executing the at least one program 203. When the at least one program 203 stored in the at least one memory 202 is executed by the at least one processor 201, various functions for supporting the city manager 140 are realized. However, the city management support apparatus 200 may be constituted by a single computer or may be constituted by a plurality of computers connected via a network.

The city management support apparatus 200 is an apparatus that does not manage the city 100 by itself but supports management of the city 100 by the city manager 140. The city management support apparatus 200 acquires information on the provision status of the resource 110. Further, the city management support apparatus 200 acquires the service definition of the service A from the service provider 120A, and acquires the service definition of the service B from the service provider 120B. Details of the service definitions will be described later.

The city management support apparatus 200 detects a competition for acquisition of the resource 110 between the services A and B based on the acquired information and the service definition. Then, a proposed amendment to the service definition of at least one of the services A and B is generated so as to optimize the competition for acquisition of the resource between the services A and B, and a proposed change to resource provision is also generated as necessary. If there is a competition for acquisition of the resource 110 among three or more services, a proposed amendment to the service definition is generated for at least one service among the three or more competition services. The city management support apparatus 200 notifies the city manager 140 of the proposed amendment to the service definition and the proposed change to the resource provision. The next section describes the city management support apparatus 200 in more detail.
2. Configuration of City Management Support Apparatus

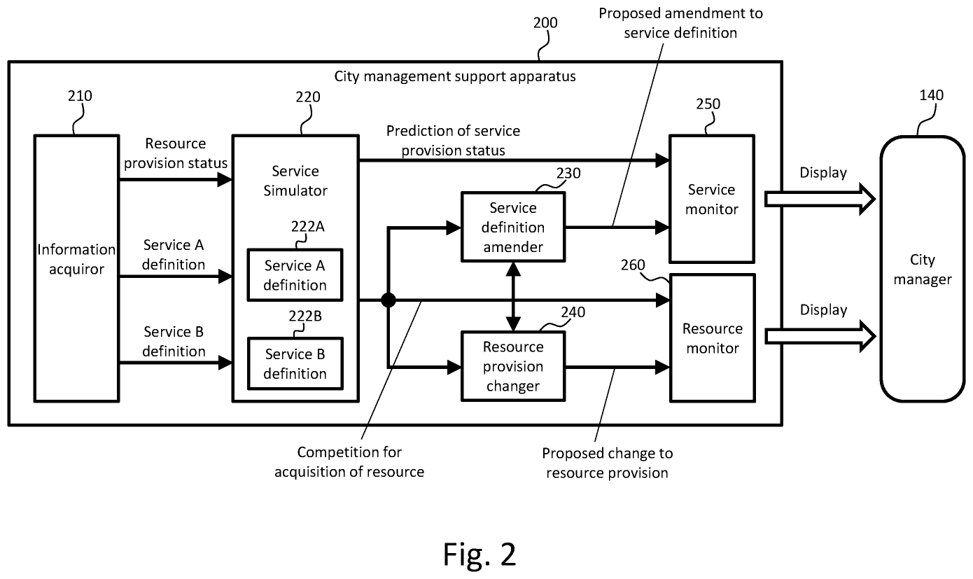

FIG. 2 is a block diagram showing the configuration of the city management support apparatus 200. The city management support apparatus 200 includes an information acquirer 210, a service simulator 220, a service definition amender 230, a resource provision changer 240, a service monitor 250, and a resource monitor 260. These elements constituting the city management support apparatus 200 are functions of the city management support apparatus 200 implemented when the at least one program 203 stored in the at least one memory 202, specifically, the city management support program is executed by the at least one processor 201.

The information acquirer 210 acquires information necessary for management of the city 100 from the city 100. The information acquired by the information acquirer 210 includes information about the provision status of the resource 110 in the city 100. The information on the provision status of the resource 110 is acquired from, for example, information detected by various sensors deployed in the city 100, information provided from the service providers 120A and 120B, or information provided from the user 130 including information on the SNS. The information on the provision status of the resource 110 acquired by the information acquirer 210 is input to the service simulator 220.

The information acquired by the information acquirer 210 includes service definitions of the respective services A and B. The service definition of the service A is acquired from the service provider 120A. The service definition of the service B is acquired from the service provider 120B. Each time each of the service providers 120A and 120B changes the service definition, it inputs the changed service definition to the information acquirer 210. The service definitions of the services A and B acquired by the information acquirer 210 are input to the service simulator 220.

The service simulator 220 is a simulator that predicts the statuses of services and the status of resource acquisition competition between services in the future by a predetermined time using a prediction model. The inputs to the service simulator 220 are information on the current provision status of the resource 110 and the service definitions of the services A and B. The service simulator 220 predicts, using the prediction model, the status of each of the services A and B in the future by a predetermined time based on the input information. The city manager 140 can arbitrarily set the predetermined time.

In the prediction model used by the service simulator 220, parameters relating to the relationship between the resource 110 and the service are created in advance in accordance with the specifications of the city 100. For example, in a case where the service provided in the city 100 is a traffic service or a logistics service, parameters such as the statuses of buildings or roads, the locations and conditions of moving bodies, a resident model, and a usage method of the moving bodies by the service are created in advance. The resident model is a model of residents in the city 100. Residents affect the relationship between resource 110 and services, such as sometimes becoming an obstacle to moving bodies and sometimes using roads. In the resident model, according to the content of the service, the movement of each resident may be simulated or the movement as a group may be simulated.

In the prediction model used by the service simulator 220, a service definition is set for each service. The service simulator 220 calculates the time transition of the provision status of each of the services A and B based on the service definition, and calculates the time transition of the dependency on the resource 110 for each service. Then, based on the time transition of the dependency, the service simulator 220 detects a competition for acquisition of the resource 110 between the services A and B. In the service simulators 220, the definition of the service A is set in the definition setting section 222A, and the definition of the service B is set in the definition setting section 222B. When a new service definition is input from the information acquirer 210, the service definitions set in the definition setting sections 222A and 222B are updated.

The service simulator 220 outputs the prediction results of the provision statuses of the services A and B and the prediction result of the competition for resource acquisition between the services A and B. The prediction results of the provision statuses of the services A and B are input to the service monitor 250. The prediction result of the competition for resource acquisition between the services A and B is input to the service definition amender 230, the resource provision changer 240, and the resource monitor 260.

The service definition amender 230 operates in response to the detection of competition for acquisition of the resource 110 between the services A and B in the service simulator 220. The service definition amender 230 generates a proposed amendment to the service definition so that the competition for acquisition of the resource 110 between the services A and B is optimized for at least one service of the services A and B. The optimization of the competition is preferably that the competition is resolved. However, the optimization of the competition may include mitigation of the competition even though the competition is not completely resolved.

The service definition amender 230 calculates a competition index indicating the competition degree by changing a parameter in the service definition with respect to all the services related to the resource on which the competition occurs, and searches for a parameter value at which the competition index becomes lowest under a predetermined constraint condition. When the service definitions of a plurality of services are amended, a combination of parameter values with the lowest competition index is searched for. Then, the service definition amender 230 determines the service definition specified by the parameter value when the competition index becomes the lowest as the proposed amendment. The proposed amendment to the service definition generated by the service definition amender 230 is input to the service monitor 250.

The resource provision changer 240 operates in response to the detection of competition for acquisition of the resource 110 between the services A and B in the service simulator 220 and the request for generation of a proposed change to the resource provision from the service definition amender 230. The resource provision changer 240 generates the proposed change to the resource provision so that the competition for acquisition of the resource 110 between the services A and B is optimized. Specifically, the resource provision changer 240 generates the proposed amendment to increase the provision amount of the resource on which the competition occurs. The proposed change to the resource provision is input to the service definition amender 230 and the resource monitor 260.

When the resource provision changer 240 generates the proposed change to the resource provision, the service definition amender 230 generates the proposed amendment to the service definition based on the proposed change. In order to optimize the competition for acquisition of the resource 110 between the services A and B, only the amendment to the service definition may be insufficient. Therefore, the service definition amender 230 and the resource provision changer 240 cooperate to generate the proposed amendment to the service definition and the proposed change to the resource provision. Specific examples of the proposed amendment to the service definition and the proposed change to the resource provision will be described later.

The service monitor 250 receives the prediction results of the provision statuses of the services A and B input from the service simulator 220, and displays them on the display. The service monitor 250 can also rewind and display the prediction results at an arbitrary time. When the proposed amendment to the service definition is input from the service definition amender 230, the service monitor 250 displays the proposed amendment to the service definition on the display. A specific example of display contents displayed on the display by the service monitor 250 will be described later.

The resource monitor 260 receives the prediction result of the competition for resource acquisition between the services A and B input from the service simulator 220, and displays it on the display. The resource monitor 260 can rewind and display the prediction result at an arbitrary time. In addition, when the proposed change to the resource provision is input from the resource provision changer 240, the resource monitor 260 displays the proposed change to the resource provision on the display. A specific example of display contents displayed on the display by the resource monitor 260 will be described later. Note that the service monitor 250 and the resource monitor 260 may share a display, or each may have a dedicated display.
3. Specific Example of City Management Support Method by City Management Support Apparatus
3-1. Example of Usage Relationship between Services and Resource

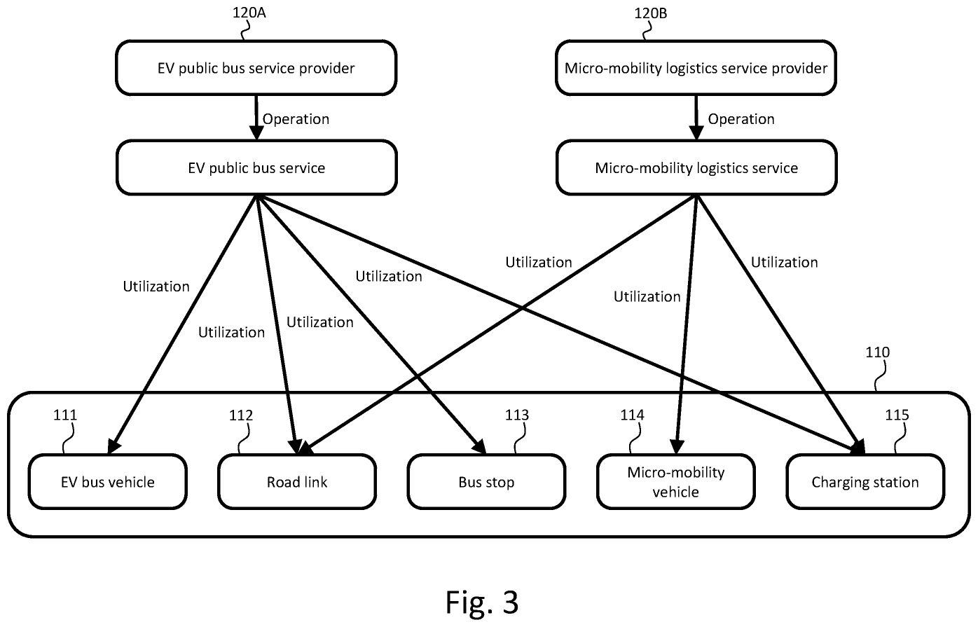

FIG. 3 is a diagram showing an example of a usage relationship between the services A and B provided in the city 100 and the resource 110. In this example, the EV public bus service is the service A, and the EV public bus service provider that operates this service is the service provider 120A. A micro-mobility logistics service is the service B, and a micro-mobility logistics service provider operating this service is the service provider 120B.

The EV public bus service is a traffic service that uses an EV bus vehicle 111 as a regular route bus. The EV bus vehicle 111 is an electric vehicle that travels with electricity stored in a battery. The EV bus vehicle 111 may be a manned vehicle driven by a driver, a remotely driven vehicle remotely driven by a remote operator, or an autonomous vehicle driven by an automated driving system.

A route on which the EV bus vehicle 111 travels is constituted by a plurality of road links 112. The road link 112 can be arbitrarily defined on the map. For example, a line segment of a road from an intersection to an adjacent intersection can be set as one road link 112. A plurality of bus stops 113 are provided on the road link 112 constituting the travel route of the EV bus vehicle 111. The EV bus vehicles 111 sequentially stop at the bus stops 113 in accordance with a preset operation schedule. In addition, the EV bus vehicle 111 is periodically charged at a charging station 115 so that the status of charge (SOC) of the battery is maintained at a certain value or more. At least one charging station 115 is installed near the road link 112.

The micro-mobility logistics service is a logistics service in which the micro-mobility vehicle 114 is used as a delivery means of a package. The micro-mobility vehicle 114 is a small electric vehicle that travels autonomously. A plurality of types of micro-mobility vehicles 114 are prepared in accordance with the types and sizes of packages to be delivered. For example, the micro-mobility vehicles 114 may include vehicles such as trash collection vehicles, laundry object distribution vehicles, personal storage vehicles, etc.

The route on which the micro-mobility vehicle 114 travels is also composed of a plurality of road links 112. While the travel route of the EV bus vehicle 111 is basically fixed, the travel route of the micro-mobility vehicle 114 may be fixed or may be changed in accordance with a package delivery schedule. In addition, since the micro-mobility vehicle 114 is an electric vehicle, charging is periodically performed at the charging station 115 so that the charge amount of the battery is maintained at a certain value or more.

In the EV public bus service, the EV bus vehicle 111, the road link 112, the bus stop 113, and the charging station 115 are used as the resource 110 of the city 100. In the micro-mobility logistics service, the road link 112, the micro-mobility vehicle 114, and the charging station 115 are used as the resource 110 of the city 100. Since the road link 112 and the charging station 115 are resources used by both the EV public bus service and the micro-mobility logistics service, there may be a competition for acquisition of the road link 112 and the charging station 115 between the EV public bus service and the micro-mobility logistics service.
3-2. Example of Time Transition of Dependency of Services on Resource

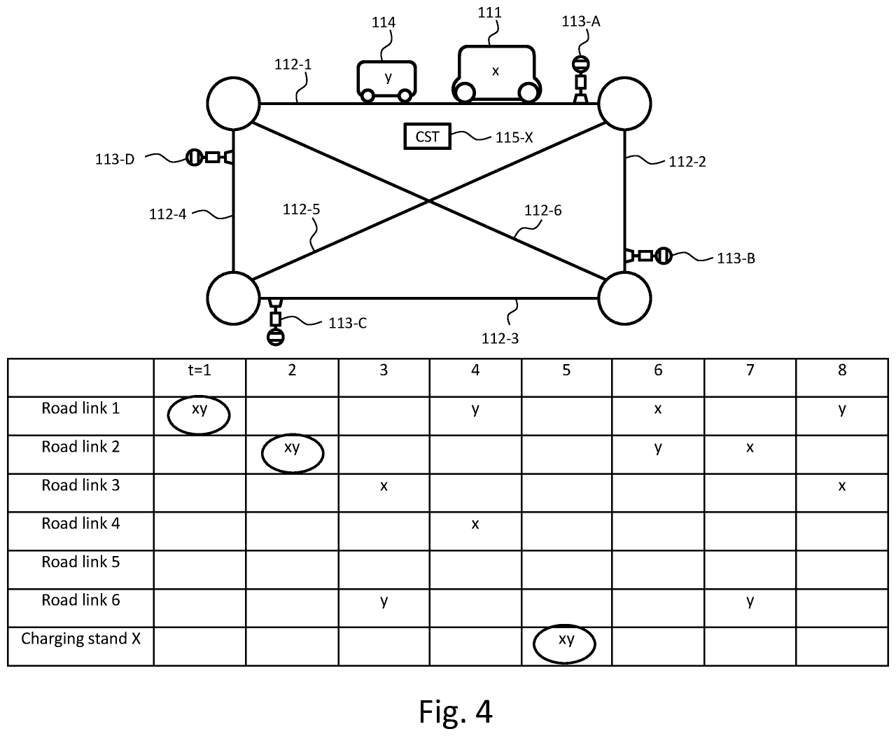

FIG. 4 illustrates a specific example of the EV public bus service and the micro-mobility logistics service (a schematic diagram illustrated in an upper part), and an example of a dependency graph (a graph illustrated in a lower part) illustrating a time transition of dependency of the EV public bus service and the micro-mobility logistics service on the resource 110.

The upper schematic diagram schematically illustrates a map of the city 100 in which the EV public bus service and the micro-mobility logistics service are provided. The map includes four road links 112-1, 112-2, 112-3, and 112-4 corresponding to the four sides of the rectangle and two road links 112-5 and 112-6 corresponding to the diagonal lines of the rectangle. Bus stops 113-A, 113-B, 113-C, and 113-D are installed on the respective road links 112-1, 112-2, 112-3, and 112-4 constituting the rectangle. A charging station 115-X is installed in the vicinity of the road link 112-1.

In the EV public bus service, the EV bus vehicle 111 is operated so as to circulate through the road links 112-1, 112-2, 112-3, and 112-4 and stop at the bus stops 113-A, 113-B, 113-C, and 113-D in order. In the micro-mobility logistics service, the road link on which the micro-mobility vehicle 114 travels is determined from among all the road links 112-1, 112-2, 112-3, 112-4, 112-5, and 112-6 based on the delivery schedule of the package.

The lower graph shows the positions of the EV bus vehicle 111 and the micro-mobility vehicle 114 at each time. In the graph, x indicates the position of the EV bus vehicle 111, and y indicates the position of the micro-mobility vehicle 114. A road link i in the graph means a road link 112-i shown in the schematic diagram (i=1 to 6). In the following description, the bus stops 113-A, 113-B, 113-C, and 113-D are referred to as bus stops A, B, C, and D, respectively, and the charging station 115-X is referred to as a charging station X.

In the example shown in the graph, the EV bus vehicle 111 travels in the order of the road links 1, 2, 3, and 4, is charged at the charging station X, and then travels again in the order of the road links 1, 2, 3, . . . . The micro-mobility vehicle 114 travels in the order of the road links 1, 2, 6, and 1, is charged at the charging station X, and then travels in the order of the road links 2, 6, 1, . . . . In this case, the EV bus vehicle 111 and the micro-mobility vehicle 114 are simultaneously present on the road link 1 at time t=1, and the EV bus vehicle 111 and the micro-mobility vehicle 114 are simultaneously present on the road link 2 at time t=2. For example, when the road links 1 and 2 are not roads on which a plurality of vehicles can travel at the same time, a competition for acquisition of the road links 1 and 2 occurs between services.

In the example illustrated in the graph, the EV bus vehicle 111 and the micro-mobility vehicle 114 are present at the same time at the charging station X at time t=5. Since the charging station X cannot charge both the EV bus vehicle 111 and the micro-mobility vehicle 114 at the same time, there is a competition for acquisition of the charging station X between services. By checking the time transition of the dependency of each service on the resource in this way, it is possible to detect the competition for acquisition of the resource between the services.
3-3. Example of Service Definition

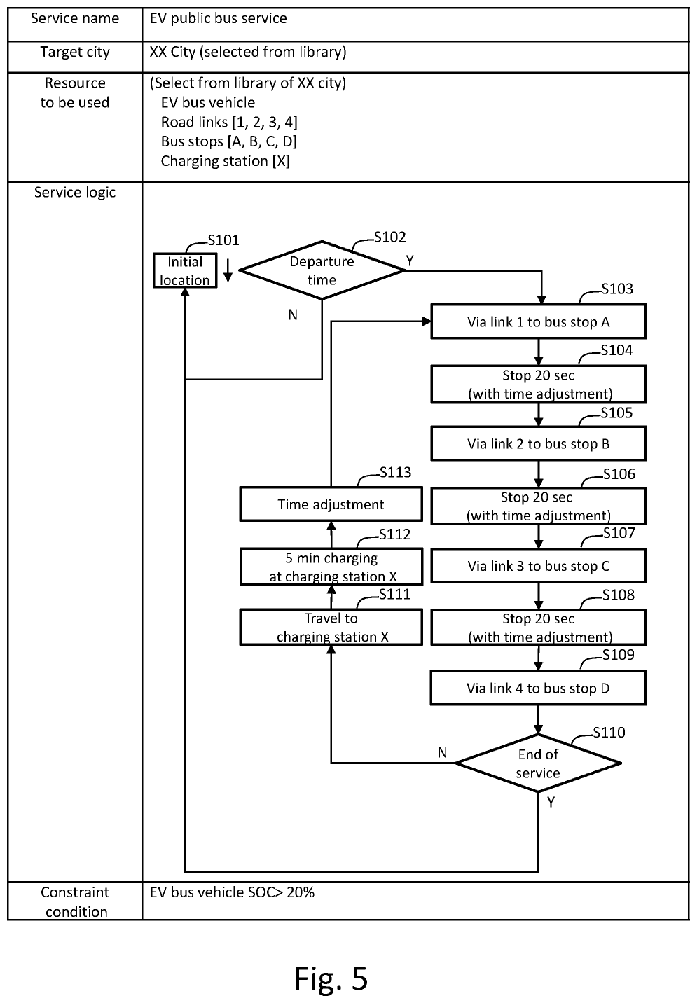

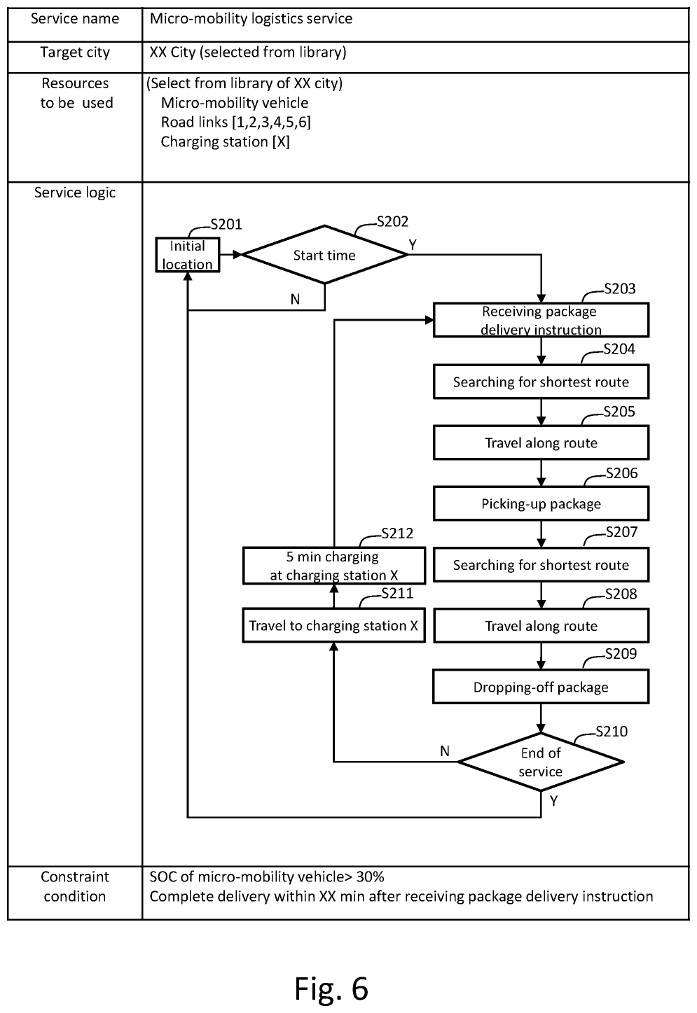

The time transition of the dependency of each service on the resource shown in the lower graph of FIG. 4 is calculated by the service simulator 220 based on the provision status of the resource and the service definition of each service. Therefore, the time transition of the dependency shown in the graph differs depending on the contents of the service definition. FIGS. 5 and 6 show examples of service definitions used in the service simulator 220. The service definition includes a service name, a target city, resources to be used, a service logic, and constraint conditions as items.

FIG. 5 shows an example of a service definition of the EV public bus service. By selecting a city in which the service is performed from a library included in the service simulator 220, it becomes possible to select resources available in the city. In the example illustrated in FIG. 5, an EV bus vehicle, road links 1, 2, 3, and 4, bus stops A, B, C, and D, and a charging station X are selected as the resources to be used. In the library, parameters such as performance (for example, speed) of the EV bus vehicle and a length of a road link are described. The service simulator 220 executes simulation by referring to the parameters of the resources selected in the library. In the library, a passenger model in which the number of passengers who get on and off at the bus stops and the time of getting on and off are defined in advance is incorporated.

The service logic is represented by a flow chart. According to the service logic of the EV public bus service illustrated in FIG. 5, the EV bus vehicle 111 waits at an initial location until departure time arrives (step S101). When the departure time has come (Yes in step S102), the EV bus vehicle 111 goes to the bus stop A via the road link 1 (step S103) and stops at the bus stop A for 20 seconds (step S104). If necessary, a time adjustment is carried out there. Next, the EV bus vehicle 111 travels to the bus stop B via the road link 2 (step S105), and stops at the bus stop B for 20 seconds (step S106). If necessary, a time adjustment is also carried out there. Next, the EV bus vehicle 111 travels to the bus stop C via the road link 3 (step S107) and stops at the bus stop C for 20 seconds (step S108). If necessary, a time adjustment is also carried out there. Further, the EV bus vehicle 111 travels to the bus stop D via the road link 4 (step S109).

When the EV bus vehicle 111 has visited all bus stops, it is determined whether or not the service is ended (step S110). If the service is ended, the EV bus vehicle 111 returns to the initial location (step S101). If the service is not ended, the EV bus vehicle 111 moves to the charging station X (step S111) and is charged at the charging station X for 5 minutes (step S112). After the time adjustment is performed in accordance with the operation schedule (step S113), the EV bus vehicle 111 again heads for the bus stop A via the road link 1 (step S103).

According to the service definition shown in FIG. 5, the constraint condition of the EV public bus service is that the charge amount of the EV bus vehicle 111 exceeds 20%. If this constraint condition is not satisfied, and if the service logic described above cannot maintain the operating schedule, it is necessary to amend the service definition or amend the service definition and change the resource provision.

FIG. 6 shows an example of a service definition of the micro-mobility logistics service. By selecting a city in which the service is performed from the library, it becomes possible to select resources available in the city. In the example illustrated in FIG. 6, a micro-mobility vehicle, a road link 1, 2, 3, 4, 5, and 6, and a charging station X are selected as resources to be used. In the library, parameters of resources including performance of the micro-mobility vehicle are described. The service simulator 220 executes simulation by referring to the parameters of the resources selected in the library. In the library, a delivery model in which a time required for picking up or dropping off a package is defined in advance is incorporated.

According to the service logic of the micro-mobility logistics service shown in FIG. 6, the micro-mobility vehicle 114 waits at an initial location until delivery start time (step S201). When the delivery start time has come (Yes in Step S202), the micro-mobility vehicle 114 receives a delivery instruction for a package (Step S203), and searches for the shortest route to a package pick-up location (Step S204). The micro-mobility vehicle 114 then travels along the shortest route to the pick-up location (step S205) and picks up the package at the pick-up location (step S206). Next, the micro-mobility vehicle 114 searches for the shortest route to a package drop-off location (step S207). The micro-mobility vehicle 114 then travels along the shortest route to the drop-off location (step S208) and drops off the package at the drop-off location (step S209).

When the micro-mobility vehicle 114 has completed delivery of the package, it is determined whether the service is ended (step S210). If the service is ended, the micro-mobility vehicle 114 returns to the initial location (step S201). If the service is not ended, the micro-mobility vehicle 114 moves to the charging station X (step S211) and charges at the charging station X for 5 minutes (step S212). Thereafter, the micro-mobility vehicle 114 receives a delivery instruction for the next package (step S203).

According to the service definition shown in FIG. 6, the constraint conditions of the micro-mobility logistics service are that the charge amount of the micro-mobility vehicle 114 exceeds 30%, and that the delivery is completed within a predetermined time after receiving the delivery instruction for the package. If these constraints conditions are not satisfied, it may be necessary to amend the service definition or amend the service definition and change the resource provision.
3-4. Example of Display of Resource Monitor and Service Monitor

The city management support apparatus 200 supports the city manager 140 by notifying the city manager 140 of support information. The notification means is the display of the support information by the resource monitor 260 and the service monitor 250.

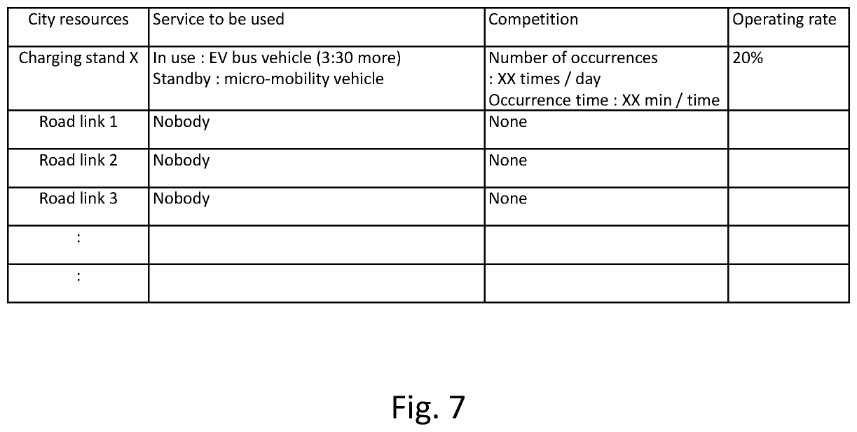

The resource monitor 260 displays the provision status of the resource as the support information. FIG. 7 shows an example of the display of the resource monitor 260. The resource monitor 260 displays resource names, services using the resources, a competition status of the resources, and a snapshot of an operation rate of the resources in a table. Since the resources shared between the EV public bus service and the micro-mobility logistics service, that is, the resources in which a competition may occur are the charging station X and the road links 1, 2, 3, and 4, the provision statuses thereof are displayed in the table. The display contents of the table can be rewound to an arbitrary time in the past from the current time, which is an internal time of the service simulator 220.

In the example illustrated in FIG. 7, it is displayed that the EV bus vehicle 111 is being charged at the charging station X and it takes 3 minutes and 30 seconds to end the charging, and that the micro-mobility vehicle 114 is on standby at the charging station X. In addition, the number of occurrences per day of the competition between the EV bus vehicle 111 and the micro-mobility vehicle 114 at the charging station X and the occurrence time per one time are displayed. Further, the operating rate of the charging station X is displayed. From these display contents, the city manager 140 can grasp that a competition occurs for acquisition of the charging station X.

Further, a dependency graph as shown in FIG. 4 may be displayed on the resource monitor 260. By observing the dependency graph, the city manager 140 can determine from a relatively long-term perspective which resource has uselessness and which resource should be replenished.

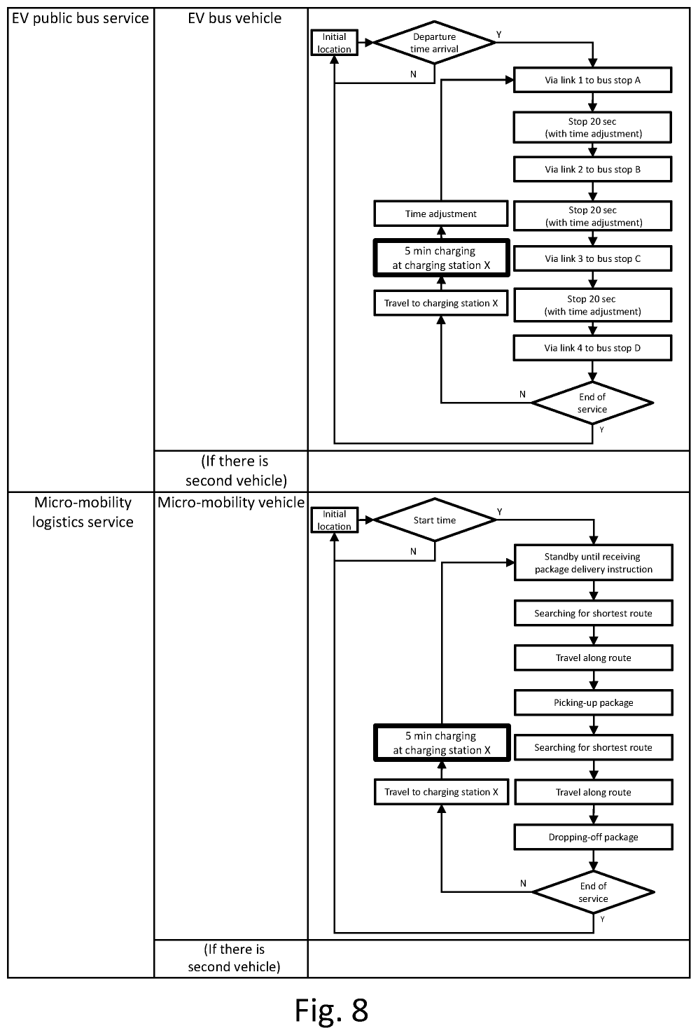

The service monitor 250 displays the provision status of each service as the support information. FIG. 8 shows an example of the display of the service monitor 250. The service monitor 250 displays a service status of the EV bus vehicle 111 used in the EV public bus service and a service status of the micro-mobility vehicle 114 used in the micro-mobility logistics service are displayed on the service monitor 250. The service status of each service is represented by a flow chart in which the block of the current time, which is an internal time of the service simulator 220, is highlighted. In particular, in the flowchart of the EV public bus service, the start time/end time of each block and the remaining time of the current block are displayed. In the flow chart of the micro-mobility logistics service, in addition to the in/out time of each block and the remaining time of the current block, the elapsed time from when the current block is in the standby status is displayed.

In the example illustrated in FIG. 8, a block described as “5-minutes charging at charging station” in the flowchart of the EV public bus service is highlighted, and the remaining time at the end of charging is displayed. In addition, a block described as “5-minute charging at charging station” in the flowchart of the micro-mobility logistics service is highlighted, and a standby time after standby for charging is displayed.

In the example shown in FIGS. 7 and 8, there is a competition between the EV public bus service and the micro-mobility logistics service for acquisition of the charging station X. An example of a method for resolving the competition is to add a charging station as a resource and use the added charging station for either the EV public bus service or the micro-mobility logistics service. For this purpose, both change to the resource provision and amendment to the service definition are required.

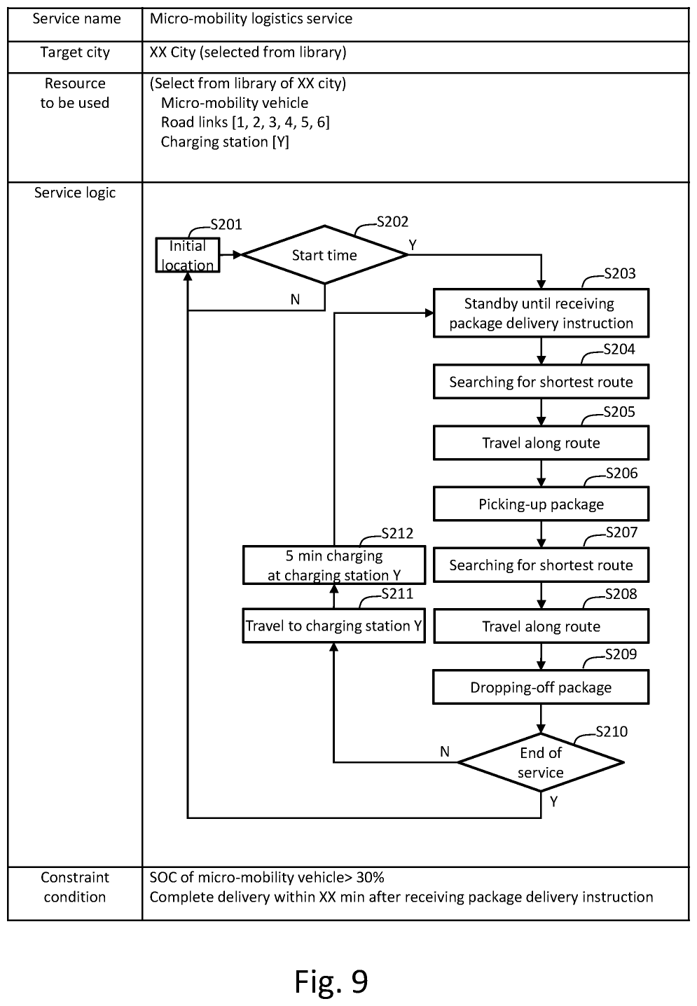

Here, it is assumed that the charging station Y is added as a resource and the service definition of the micro-mobility logistics service is amended. In this case, although not illustrated, the charging station Y is added to the table illustrated in FIG. 7, and the table to which the charging station Y is added is displayed on the resource monitor 260. In addition, a proposed amendment to the service definition of the micro-mobility logistics service as illustrated in FIG. 9 is generated, and the proposed amendment is displayed on the service monitor 250. In the example shown in FIG. 9, the resource to be used is replaced from the charging station X to the charging station Y, and the contents of the blocks of step S211 and step S212 are changed accordingly.

The city manager 140 confirms the display of the resource monitor 260, and requests the provider of the charging station as the resource to add the charging station Y. The addition of the charging station Y means that power is supplied to the new installed charging station Y and the micro-mobility vehicle 114 can be charged using the charging station Y. Further, the city manager 140 confirms the display of the service monitor 250 and requests the micro-mobility logistics service provider 120B to amend the service definition according to the proposed amendment shown in FIG. 9. Thus, the relationship between resources and services in the city 100 is optimized.
4. Others

In the above-described embodiment, the number of each of the EV bus vehicle 111 and the micro-mobility vehicle 114 is one. However, in a case where there are a plurality of vehicles, a plurality of proposed amendments to the service definition can be generated. For example, in a time zone in which the number of operating EV bus vehicles 111 is large in the daytime, it is also possible to generate a proposed amendment to the service definition such that the charging frequency of the micro-mobility vehicle 114 is reduced by giving priority to the charging of the EV bus vehicle 111, and the charging time of the micro-mobility vehicle 114 in the nighttime is lengthened.

What is claimed is:

1. A city management support apparatus that supports management of a city in which a plurality of services sharing a physical resource are provided, the city management support apparatus comprising:
at least one memory storing at least one program; and
at least one processor configured to execute the at least one program,
wherein the at least one program is configured to cause the at least one processor to execute:
receiving an input of information on a provision status of the resource;
receiving an input of a service definition for each of the plurality of services;
calculating a time transition of dependency of the plurality of services on the resource based on the service definition for each of the plurality of services;
detecting a competition for acquisition of the resource among the plurality of services based on the time transition of the dependency; and
generating a proposed amendment to the service definition for at least one of the plurality of services so as to optimize the competition for the acquisition of the resource among the plurality of services.

2. The city management support apparatus according to claim 1,
wherein the at least one program is configured to cause the at least one processor to further execute generating a proposed change to provision of the resource so as to optimize the competition for the acquisition of the resource among the plurality of services.

3. A city management support method for supporting, using a computer, management of a city in which a plurality of services sharing a physical resource are provided, the city management support method comprising:
inputting information on a provision status of the resource into the computer;
inputting a service definition for each of the plurality of services into the computer;
calculating, by the computer, a time transition of dependency of the plurality of services on the resource based on the service definition for each of the plurality of services;
detecting, by the computer, a competition for acquisition of the resource among the plurality of services based on the time transition of the dependency; and
generating, by the computer, a proposed amendment to the service definition for at least one of the plurality of services so as to optimize the competition for the acquisition of the resource among the plurality of services.

4. A non-transitory computer-readable storage medium storing a city management support program for causing a computer to execute processing for supporting management of a city in which a plurality of services sharing a physical resource are provided, the processing comprising:
receiving an input of information on a provision status of the resource;
receiving an input of a service definition for each of the plurality of services;
calculating a time transition of dependency of the plurality of services on the resource based on the service definition for each of the plurality of services;
detecting a competition for acquisition of the resource among the plurality of services based on the time transition of the dependency; and
generating a proposed amendment to the service definition for at least one of the plurality of services so as to optimize the competition for the acquisition of the resource among the plurality of services.
